(19) United States
(12) Patent Application Publication
(10) Pub. No.: US 2015/0354468 A1
(43) Pub. Date: Dec. 10, 2015

(54) CONTINUOUS VARIABLE VALVE TIMING WITH INTERMEDIATE LOCK PIN AND METHOD FOR CONTROLLING THE SAME

(71) Applicants: HYUNDAI MOTOR COMPANY, Seoul (KR); KIA MOTORS CORPORATION, Seoul (KR)

(72) Inventor: Hyun Kim, Hwaseong (KR)

(21) Appl. No.: 14/530,183

(22) Filed: Oct. 31, 2014

(30) Foreign Application Priority Data
Jun. 9, 2014 (KR) 10-2014-0069344

(51) Int. Cl. F02D 13/02; F01L 1/348; F01L 1/344

(52) U.S. Cl. CPC F02D 13/0203; F01L 1/3442; F01L 1/348

(57) ABSTRACT

A continuous variable valve timing with an intermediate lock pin and includes a camshaft, with a cam that protrudes from the camshaft, configured to lift a valve. In addition, a variable device is disposed at one side of the camshaft with a retarded angle chamber and an advanced angle chamber disposed therein. An oil control valve is configured to supply the retarded angle chamber or the advanced angle chamber with hydraulic pressure to retard or advance the rotation of the camshaft, respectively. Furthermore, a cam position detector is configured to detect a rotation position of the cam. A controller is configured to detect a signal of the rotation position of the camshaft from the cam position detector and vary a frequency of a PWM duty configured to operate the oil control valve, when a variation characteristic of the signal of the rotation position exceeds a predetermined range.

### CROSS-REFERENCE TO RELATED APPLICATION

This application claims priority to Korean Patent Application No. 10-2014-0069344 filed on Jun. 9, 2014, the entire contents of which are incorporated herein by reference.

### BACKGROUND

(a) Field of the Invention

The present invention relates to a continuous variable valve timing with intermediate lock pin that variably adjusts an intake valve lift timing to an advanced condition, a middle condition, and a retarded condition which improves energy consumption efficiency and energy output.

(b) Description of the Related Art

An internal combustion engine generates power by burning fuel within a combustion chamber with an air media drawn into the chamber. A camshaft is configured to operate intake valves to suction the air. The air is then drawn into the combustion chamber while the intake valves are open. Additionally, the camshaft is also configured to operate exhaust valves, and a combustion gas is removed from the combustion chamber while the exhaust valves are open.

However, an optimal operation of the intake valves and the exhaust valves is based on driving conditions such as a rotation speed and a load of the engine. In other words, optimal opening and closing times of the valves or an optimal lift is based on the rotation speed of the engine. Accordingly, methods for retarding or advancing a lift timing of a valve were introduced, and the combustion efficiency may be improved by adjusting the lift timing of the valve based on a driving condition of the engine. More particularly, a continuous variable valve control system is configured to optimally adjust opening and closing timing of the valve of the engine based on the engine speed where fuel consumption efficiency is improved, exhaust gas production is decreased, low speed torque is increased, and overall energy output is improved.

Further, a valve overlap of an intake valve and an exhaust valve is increased to reduce a pumping loss where fuel consumption efficiency is increased. A valve overlap is optimized based on an engine condition where unburned gas is combusted by an inner exhaust gas so exhaust gas is reduced. An intake valve timing is optimized based on an engine condition where volume efficiency is improved and low speed torque and energy output are increased.

Recently, continuous variable valve timing (CVVT) with an intermediate lock pin has been developed to improve responsiveness and expand operation of a conventional CVVT system. Continuous variable valve timing with intermediate lock pin is configured to adjust the position of a cam to a substantially middle position between a retarded position and an advanced position. By improving the responsiveness and expanding the usage area of the cam, fuel consumption efficiency increases and exhaust gas production decreases.

However, when resonance is generated on a pulse width modulation (PWM) control frequency of a solenoid valve and a cam, a cam position may fluctuate. When the cam position fluctuates, cam controlling and stability may be negatively affected, and engine performance and stability may deteriorate.

The above information disclosed in this section is merely for enhancement of understanding of the background of the invention and therefore it may contain information that does not form the prior art that is already known in this country to a person of ordinary skill in the art.

### SUMMARY

The present invention provides a continuous variable valve timing with an intermediate lock pin that may reduce cam rotation position fluctuation in a cam control structure where the cam may be retarded or advanced via an oil control valve which may improve engine performance and stability.

A continuous variable valve timing with an intermediate lock pin according to an exemplary embodiment of the present invention may include a camshaft with a cam that protrudes from the camshaft configured to lift a valve, a variable device (e.g., sprocket) disposed at one side of the camshaft, a retarded angle chamber and an advanced angle chamber disposed within the variable device, an oil control valve configured to supply the retarded angle chamber or the advanced angle chamber with hydraulic pressure which may retard or advance the rotation of the camshaft, respectively, a cam position detector configured to detect a rotation position of the cam, and a controller configured to detect a signal of the rotation position of the camshaft from the cam position detector and adjust a frequency of a PWM duty to operate the oil control valve, when a variation characteristic of the signal of the rotation position exceeds a predetermined range. The variation characteristic may include a vibration width of the signal. The variation characteristic may further include a difference value between the signal and a predetermined target value. The predetermined target value may be varied in response to a driving condition of an engine.

The variable device may include a locking pin configured to lock a position of the cam to a substantially middle position (e.g., between an advanced position and a retarded position). Further, the variable device may also include a torque receiving portion configured to receive a torque via a chain or a belt. When the controller adjusts the frequency of the PWM duty to operate the oil control valve and the variation characteristic of the signal is within a predetermined range, the frequency of the PWM duty may be returned to an initial value. In response to determining that a cam position exceeds predetermined width, the frequency of the PWM duty may be varied to prevent cam position fluctuation.

Further, since cam position fluctuation may be prevented, the stability of the cam may be improved and the engine performance may also be improved.

### BRIEF DESCRIPTION OF THE DRAWINGS

The above and other features of the present invention will now be described in detail with reference to exemplary embodiments thereof illustrated in the accompanying drawings which are given herein below by way of illustration only, and thus are not limitative of the present invention, and wherein:

FIG. 1 is an exemplary partial schematic inner side-view of continuous variable valve timing with intermediate lock pin and an exemplary graph showing a valve lift according to an exemplary embodiment of the present invention;

FIG. 2 is an exemplary flowchart showing a control method in a control system of a variable valve lift apparatus according to an exemplary embodiment of the present invention; and

FIG. 3 is an exemplary graph showing movement of a valve in a variable valve lift apparatus according to an exemplary embodiment of the present invention.

### DESCRIPTION OF SYMBOLS

100: sprocket
110: advanced angle chamber
120: locking pin
130: retarded angle chamber
140: oil control valve
150: controller
160: cam position sensor
170: camshaft

### DETAILED DESCRIPTION OF THE EMBODIMENTS

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

Furthermore, control logic of the present invention may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

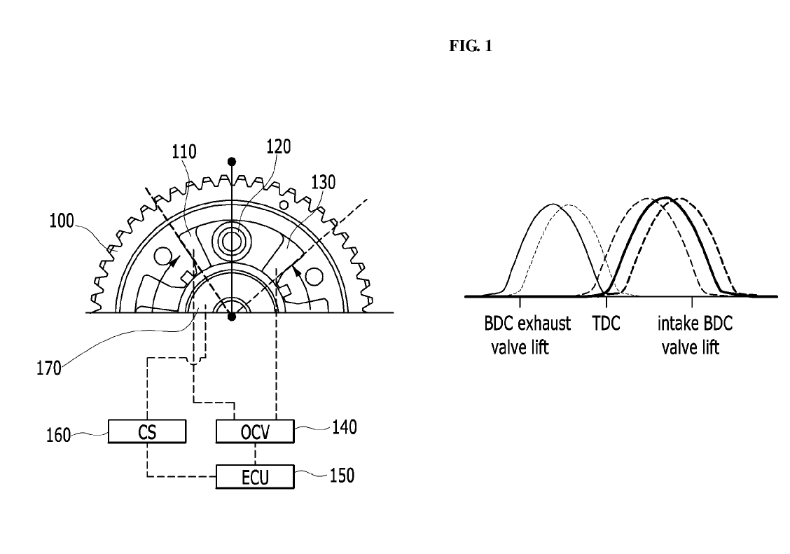

An exemplary embodiment of the present invention will hereinafter be described in detail with reference to the accompanying drawings. FIG. 1 is an exemplary partial schematic inner side-view of continuous variable valve timing with intermediate lock pin and an exemplary graph showing a valve lift according to an exemplary embodiment of the present invention. Referring to FIG. 1, a continuous variable valve timing with an intermediate lock pin may include a cam shaft 170 with a cam (not shown) formed thereon, a sprocket 100 with an advanced angle chamber 110 and a retarded angle chamber 130 disposed within the sprocket 100, a locking pin 120, a cam position sensor 160, an oil control valve 140, and a controller 150.

The cam position sensor 160 may be executed by the controller 150 to detect a position of the cam disposed on the camshaft 170 and transmit the detected signal to the controller 150. The controller 150 may be configured to calculate or select a rotation position or a cam position of the camshaft 170 via the transmitted detection signal and adjust the oil control valve 140 in response to the driving condition. The oil control valve 140 may be configured to supply the advanced angle chamber 110 or the retarded angle chamber 130 with hydraulic pressure to retard or advance the camshaft 170 based on the sprocket 100, respectively. In other words, when hydraulic pressure is supplied to the advanced angle chamber 110, the camshaft 170 may be configured to rotate clockwise direction relative to the sprocket 100 and the cam may be advanced. Further, when hydraulic pressure is supplied to the retarded angle chamber 130, the camshaft 170 may be configured to rotate counter-clockwise direction relative to the sprocket 100 and the cam may be retarded.

The locking pin 120 may be operated by hydraulic pressure supplied separately. The locking pin 120 may be configured to fix the sprocket 100 with the camshaft 170 to fix the sprocket 100 to a substantially middle position on the camshaft 170 (e.g., between a retarded position and an advanced position). Accordingly, an exhaust valve or an intake valve may be configured to be adjusted in an advanced position, a substantially middle position, and a retarded position based on a driving condition of an engine.

In an exemplary embodiment of the present invention, the sprocket 100 may be configured to receive torque from a crankshaft of an engine via a chain. Additionally, the sprocket 100 may be replaced by a pulley. In particular, the pulley may also be configured to receive torque from a crankshaft of an engine via a belt.

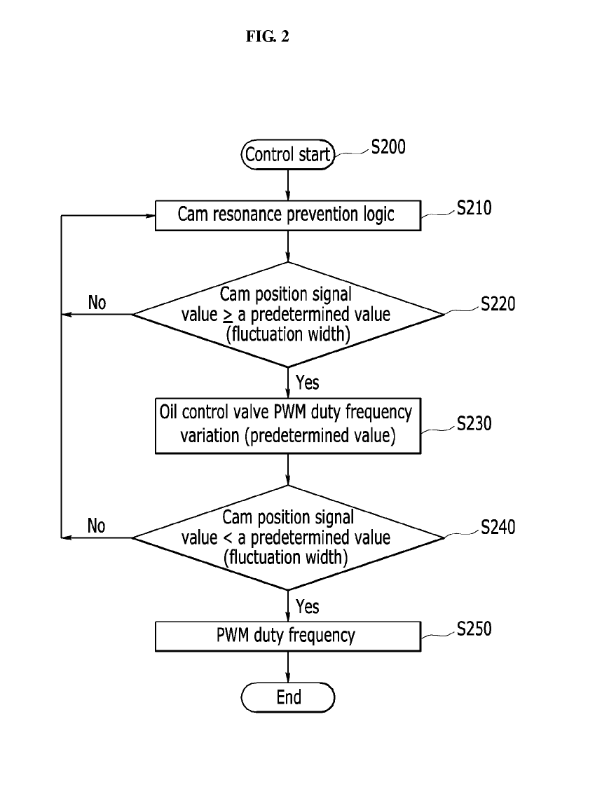

FIG. 2 is an exemplary flowchart showing an exemplary control method in a control system of a variable valve lift apparatus according to an exemplary embodiment of the present invention. Referring to FIG. 2, the controller 150 may be configured to start the method S200. The controller may then be configured to perform cam resonance prevention logic S210. In response to the cam resonance prevention logic, the controller 150 may be configured to supply the advanced angle chamber 110 or the retarded angle chamber 130 with hydraulic pressure and adjust the position of the camshaft 170 to prevent fluctuation of the rotation position of the camshaft 170.

The controller 150 may be configured to detect the rotation position of the camshaft 170 using the cam position sensor 160. A detection signal may be configured to repeat ascent and descent within a predetermined range to form a variation width. Additionally, the controller 150 may be configured to determine when the variation width exceeds a predetermined value S220. When the variation width of the detection signal exceeds a predetermined value, the controller 150 may be configured to adjust a frequency of a signal to adjust a PWM duty of the oil control valve 140 to a predetermined value S230.

Further, the controller 150 may be configured to detect a rotation position of the camshaft 170 using the cam position sensor 160 and determine when the variation width of the detection signal exceeds a predetermined value S240. When the variation width is less than a predetermined value, the controller 150 may be configured to reinstate the frequency of the signal to adjust the PWM duty of the oil control valve 140 S250. In addition, when the variation width is larger than the predetermined value, cam resonance prevention logic S210 or determining when the variation width exceeds a predetermined value S220 may be performed.

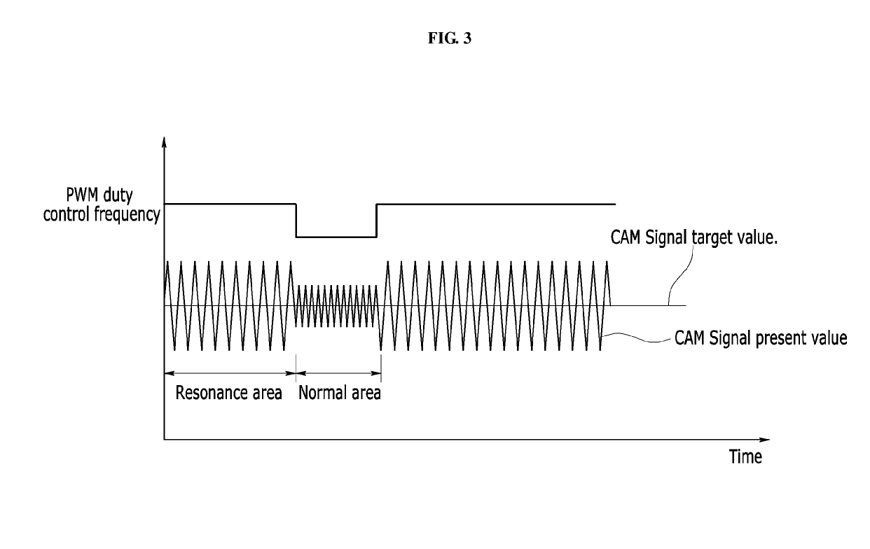

FIG. 3 is an exemplary graph showing movement of a valve in a variable valve lift apparatus according to an exemplary embodiment of the present invention. Referring to FIG. 3, a horizontal axis denotes time and a vertical axis denotes frequency of PWM duty to operate the oil control valve 140 and a position of the cam. The cam position may correspond to the rotation position of the camshaft 170, a target value thereof may be set based on a driving condition, and the cam position may be varied in response to the target value. However, the cam position may fluctuate at a predetermined frequency within a predetermined area based on the target value, due to the variation of the hydraulic pressure supplied from the oil control valve 140 and other factors.

When a resonance area, an area where the variation width of the cam position exceeds a predetermined value, exists (, a control frequency of a PWM duty to operate the oil control valve may be varied to decrease the variation width and adjust the resonance area to a normal area (e.g., when an area where the variation width is less than a predetermined value). In an exemplary embodiment of the present invention, when the variation width of the cam position exceeds a predetermined value, the variation width may be a resonance area. Additionally, the variation width of the cam position may be calculated based on the target value.

While this invention has been described in connection with what is presently considered to be practical exemplary embodiments, it is to be understood that the invention is not limited to the disclosed exemplary embodiments, but, on the contrary, is intended to cover various modifications and equivalent arrangements included within the spirit and scope of the appended claims.

What is claimed is:

1. A continuous variable valve timing with an intermediate lock pin, comprising:
a camshaft having a protruding cam disposed thereon configured to lift a valve;
a variable device disposed at one side of the camshaft and a retarded angle chamber and an advanced angle chamber disposed within the variable device;
an oil control valve configured to supply the retarded angle chamber or the advanced angle chamber with hydraulic pressure to retard or advance the rotation of the camshaft, respectively;
a cam position detector configured to detect a rotation position of the cam; and
a controller configured to:
detect a signal of the rotation position of the camshaft from the cam position detector; and
adjust a frequency of a pulse width modulation (PWM) duty to operate the oil control valve, when a variation characteristic of the signal of the rotation position exceeds a predetermined range.

2. The continuous variable valve timing with an intermediate lock pin of claim 1, wherein the variation characteristic includes a vibration width of the signal.

3. The continuous variable valve timing with an intermediate lock pin of claim 1, wherein the variation characteristic includes a difference between the signal and a predetermined target value.

4. The continuous variable valve timing with an intermediate lock pin of claim 1, wherein the predetermined target value is varied based on a driving condition of an engine.

5. The continuous variable valve timing with an intermediate lock pin of claim 1, wherein the variable device further includes:
a locking pin configured to lock a position of the cam to a substantially middle position between an advanced position and a retarded position.

6. The continuous variable valve timing with intermediate lock pin of claim 1, wherein the variable device further includes:
a torque receiving portion configured to receive a torque, via a chain or a belt.

7. The continuous variable valve timing with intermediate lock pin of claim 1, wherein the controller is further configured to:
adjust the frequency of the PWM duty to operate the oil control valve to an initial value, when the variation characteristic of the signal is within a predetermined range.

8. A method for controlling a continuous variable valve timing with an intermediate lock pin, comprising:
detecting, by a controller, a signal of the rotation position of a camshaft from a cam position detector; and
adjusting, by the controller, a frequency of a pulse width modulation (PWM) duty configured to adjust the oil control valve, when a variation characteristic of the signal of the rotation position exceeds a predetermined range.

9. The method of claim 8, wherein the variation characteristic includes a vibration width of the signal.

10. The method of claim 8, wherein the variation characteristic includes a difference between the signal and a predetermined target value.

11. The method of claim 10, wherein the predetermined target value is varied based on a driving condition of an engine.

12. The method of claim 8, further comprising
adjusting, by the controller, the frequency of the PWM duty configured to adjust the oil control valve to an initial value, when the variation characteristic of the signal is within a predetermined range.

13. A non-transitory computer readable medium containing program instructions executed by a controller, the computer readable medium comprising:
program instructions that detect a signal of the rotation position of the camshaft from the cam position detector; and
program instructions that adjust a frequency of a pulse width modulation (PWM) duty configured to adjust the oil control valve, when a variation characteristic of the signal of the rotation position exceeds a predetermined range.

14. The non-transitory computer readable medium of claim 13, further comprising:
program instructions that adjust the frequency of the PWM duty configured to adjust the oil control valve to an initial value, when the variation characteristic of the signal is within a predetermined range.
